(19) United States
(12) Patent Application Publication
(10) Pub. No.: US 2007/0054538 A1
(43) Pub. Date: Mar. 8, 2007

(54) Releasable Cord Coupler

(75) Inventors: Mark Smith, Cedar Park, TX (US); Robert Hasler, Cedar Park, TX (US)

Correspondence Address: Alliance Inventioneering, Ste H-181, 1525 Cypress Creek Rd, Cedar Park, TX, 78613, US

(73) Assignee: ALLIANCE INVENTIONEERING, Cedar Park, TX (US)

(21) Appl. No.: 11/162,053

(22) Filed: Aug. 26, 2005

(51) Int. Cl. H01R 13/62

(52) U.S. Cl. 439/369

(57) ABSTRACT

A releasable cord coupler in a single embodiment consisting of an enlongated linear strap with a tapered tail, two apertures and a slot through the planar surface of the strap, a plurality of ratcheted teeth affixed to the bottom side of the strap, a slide located around the strap, and a head with a pawl inserted therein that receives the tail and engages the ratcheted teeth. The cord coupler prevents the accidental uncoupling of an electrical appliance from an electrical extension cord. The cord coupler may also be used to bind two extension cords. When storing a hand tool or extension cord equipped with the cord coupler, the cord coupler may be used to secure the power tool cord to the tool or to secure a coiled extension cord for storage.

### BACKGROUND OF THE INVENTION

This invention relates to the field of devices for securing electrical connectors, such as the male and female ends associated with power conducting cords used for extension cords and power tool electrical cords and the like, in assembled, united or mated engagement so that the plugs are prevented from being accidentally separated. (U.S. Class 439/369, 439/371) Additional claims relate to the field of devices that are used to bundle a plurality of cords or ropes. (U.S. Class 24/1 6PB)

It is an identified problem in the prior art that male and female plugs on the ends of power conductors such as electrical extension cords and power tool electrical cords and the like may be accidentally separated if the junction between the cords is pulled under tension without some sort of restraining device coupling the male and female plugs together in mated engagement.

It is known that most power tools and heavy-duty appliances include a relatively short power cord or rigid receptacle having a pronged male electrical connector at the end thereof. Typically the ends of the power cords are the only means provided by which extension cords may be connected to the power cords to provide power to the tools. Power tools are routinely used with extension cords and a user while moving about, for example at a work site, will quite often reach an outer limit of the range afforded by the extension cord and will inadvertently pull on the power tool thereby separating the junction between the power tool cord and the extension cord. More frustratingly, a junction between connected extension cords removed from the location of the user requires the user to walk across the job site to locate separated connectors between extension cords. Quite apart from the aggravation and inefficiency of such a situation, the partial separation of electrical connectors also creates an electrical shock hazard.

A common practice among operators is to tie a single over-hand knot between the two ends of the cords and then couple the male and female ends together. While preventing accidental release, this solution causes the conductors to be bent at an acute angle. Over time, this repeated bending could cause the cord to fail at the junction of the cord conductors and the cord plug.

Consequently, the need identified in the prior art and attempted to be solved in the prior art exists to secure, by means of a releasable mountable device, male and female electrical plugs in mated engagement to prevent accidental release. In the prior art:

The plug retention device (U.S. Pat. No. 5,336,107 Sheryll August 1994) uses two discrete units that are attached to the male and female plugs by circumferential clamps. The devices are molded plastic, formed to planar surfaces upon which are formed a plurality of “mushroom” shaped protrusions. Attached to the clamp at each plug are two of these surfaces that engage the surfaces on the opposite plug. While functional as a cord coupler, this solution has two deficiencies. First is that a matching retention device must be attached to the opposite electrical plug, thereby limiting its use to only those extension cords that have been herewith equipped. Secondly, this device may only be used to couple the two plugs together and therefore has no utility as a device to bind the cord into a coil for storage.

The securing device for mating electrical cords (U.S. Pat. No. 5,733,138 Kramer March 1998) uses enlongated straps made of hook and loop material (Velcro) with commercially available opening metal rings to create a couple between the two plugs. The invention requires multiple operator steps to create the couple and appears awkward to use. Releasing the couple appears to be equally complex. The rings do not appear to be affixed permanently to the straps and are at risk of being lost to the assembly over time. Additionally, “Velcro” is susceptible to collecting dirt and debris and is not durable for outdoor use

The releasable cord coupler (U.S. Pat. No. 6,217,366 Weisstock April 2001) uses enlongated straps made of hook and loop material (Velcro) attached to each cord at the junction of the cord and the plug. This device improves upon Kramer above by replacing the metal rings with a Velcro strap that is integral to the cord coupler. The device solves several problems of Kramer such as ease of operation and retention of the device on the cord. However, it again suffers from durability of the Velcro straps and the need for two of these devices, one on each of the male and female plugs, to function properly.

The releasable cable tie (U.S. Pat. No. 6,185,791 Khokhar February 2001) is an enlongated plastic strap on the bottom side of which are formed a plurality of ratcheted teeth, with a tapered end and a head end in which is formed an integral hinged pawl which engages the teeth after the tapered end is inserted into the head. This device is releasable by pressing the pawl. This form of this device is very useful to bind together a plurality of electrical cords but lacks three needed features to function as a cord coupler. One, without an aperture through the planar surface of the strap, this device cannot be secured to an electrical cord or plug. Two, the perpendicular orientation of the aperture in the head is awkward for use in a cord coupler. Finally, the durability of the hinge attaching the pawl to the head is in doubt.

While each of these devices have some utility as a cord coupler, none of them employ a single embodiment that can both couple the two plugs together and be used to bind the cord into a coil for storage.

### BRIEF SUMMARY OF THE INVENTION

A releasable cord coupler consisting of an enlongated linear strap with a tapered tail, a plurality of ratcheted teeth on one side, apertures and a slot through the planar surface of the strap, a retaining slide that encompasses the strap, and a head with a sliding pawl inserted therein that receives the tail and engages the ratcheted teeth. The cord coupler prevents the accidental uncoupling of an electrical appliance from an electrical extension cord. The cord coupler normally remains attached to the male end of the cord. When attaching an electrical appliance to an extension cord, the female plug end is inserted through the slot in the cord coupler and then is secured by moving the slide up to the female plug. The two cords are then plugged together. The operator then inserts the ratcheted strap of the cord coupler into the head until the pawl engages it, thus creating a couple immune from accidental release. When the operator is finished, the pawl is depressed and the strap removed from the head. The female plug is then removed out of the slot and the cords are uncoupled. When storing a hand tool or extension cord equipped with the cord coupler, the cord coupler may be used to secure the power tool cord to the tool or to secure a looped extension cord for storage. The cord coupler may also be used to bind two extension cords.

### BRIEF DESCRIPTION OF THE SEVERAL VIEWS OF THE DRAWING

FIG. 1 is the orthographic top view of the cord coupler.

FIG. 2 is the orthographic bottom view of the cord coupler.

FIG. 3 is the orthographic side view of the cord coupler.

FIG. 4 is an isometric view of the cord coupler that demonstrates claim 1.

Figure I is the orthographic side sectional view of the head assembly.

Figure II is the orthographic front sectional view of the head assembly.

Figure III is the orthographic side sectional view of the slide.

Figure IV is the orthographic front sectional view of the slide.

### DETAILED DESCRIPTION OF THE INVENTION

The releasable cord coupler improves upon the previous teachings through its unitary embodiment and its dual use. The cord coupler is attached to the male end of any electrical cord. The female end is inserted through the strap of the cord coupler and then the strap is inserted into the head thereby coupling the male and female electrical plugs together to prevent accidental release. Additionally, after the release of the female end from the coupler, the strap may be used to bundle the electrical cord into a coil for storage or transport.

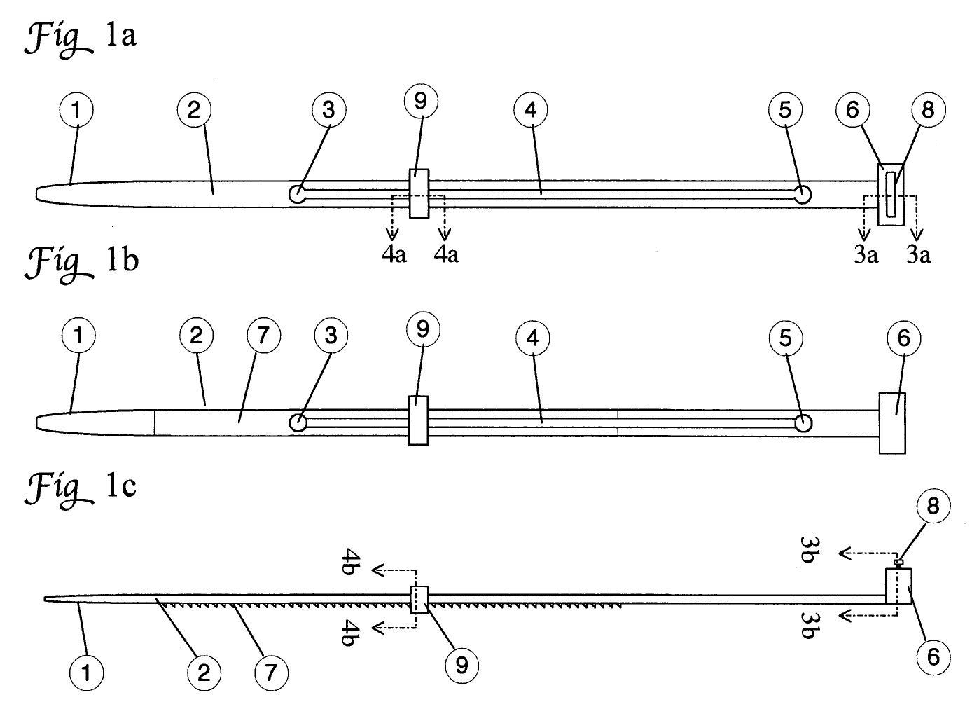

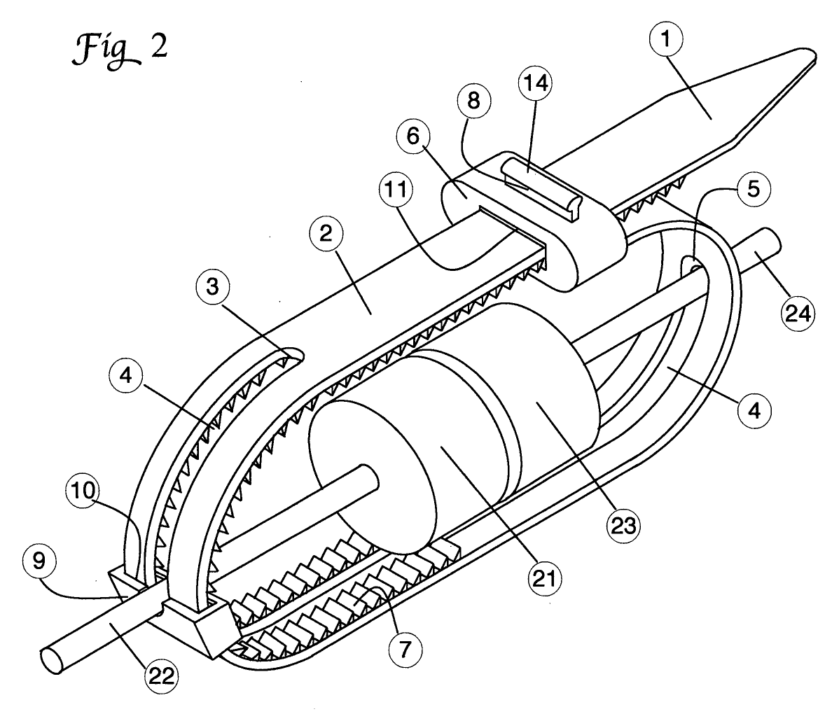

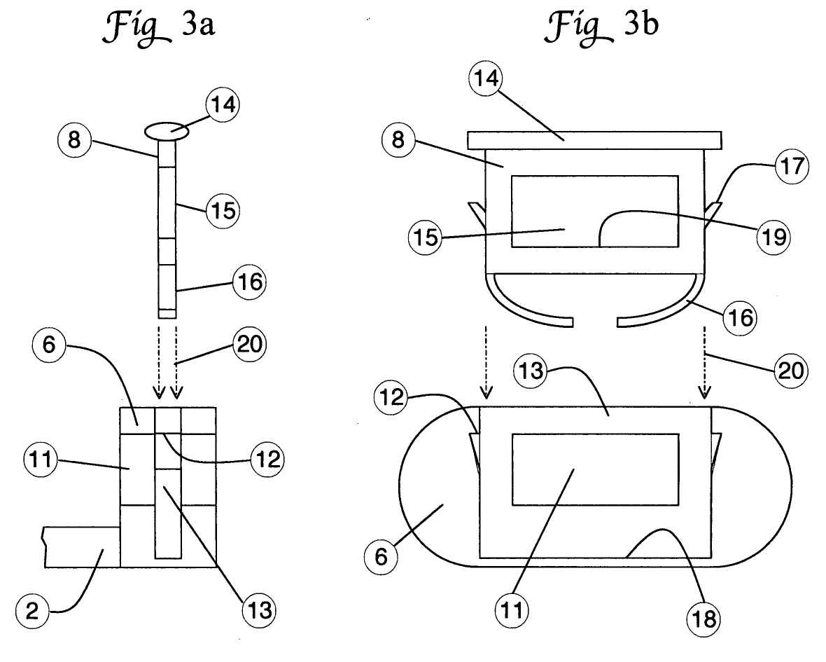

Observing FIGS. 1, 2 and 3, the cord coupler, in a single embodiment, is composed of an enlongated linear strap (2) with a tapered tail (1), a plurality of ratcheted teeth on one side (7), apertures (3 & 5) and a slot (4) through the planar surface of the strap, a retaining slide (9) that encompasses the strap, and a head (6) with a sliding pawl (8) inserted therein that receives the tail (1) and engages the ratcheted teeth (7).

The long flexible strap (2) is constructed of injected or cut plastic, nylon or fiber reinforced rubber or other suitable flexible and tensionally strong material. The top planar surface is enlongated in the longitudinal and narrow in the lateral dimensions.

Down through this surface is formed a first aperture (5) of sufficient diameter to accommodate circumferentially an electrical cord and is located on the planar surface portion of the strap centered on the longitudinal axis near the head. A second aperture (3) is formed likewise and is of sufficient diameter to accommodate circumferentially an electrical cord and is located on the planar surface of the strap centered on the longitudinal axis a sufficient distance longitudinally from the first aperture to allow both male and female plugs to be uncoupled when the pawl is released. Bisecting the two apertures and centered on the longitudinal centerline, a substantially linear slot (4) is cut or molded that allows the male and female plugs to be inserted through the strap.

A plurality of ratcheted teeth (7) is cut or molded into the bottom of the strap (2) of sufficient depth to prevent uncoupling of the extension cord when tension is applied and shaped to allow insertion into the head (6) without pressing the pawl (8) and shaped to require pressing the pawl to release the strap from the head.

The tail (1) end is tapered to reduce the width and height of the strap sufficiently to allow insertion into the head (6).

The head (6) end is located opposite the tail in the longitudinal direction and is located on the top planar surface of the strap (2). Observing the cross-sectional Figures I and II, a rectangular aperture (11) is formed through the longitudinal direction that will allow the width and height of the strap to pass through the head. A second rectangular aperture (13) is formed passing down into the depth of the head, but not through, that allows the pawl (8) to move up and down to engage and release the ratcheted teeth (7) on the strap. Within this second aperture (13), two steps (12) are formed, one on each side in the lateral dimension, that provide an engagement planar surface for the two barbs (17) of the pawl (8).

The pawl (8) is formed of injected or cut plastic, nylon or other suitable semi-rigid material that is substantially planar in the lateral and depth dimensions and is located within the aforementioned aperture (13) in the head (6).

A rectangular aperture (15) is cut or molded through the planar surface centered on the lateral center line of the pawl of sufficient dimension to allow the strap to pass through longitudinally and positioned in height on the planar surface so that when the pawl is inserted in the head and pressed it will allow the strap to be removed through both the aperture in the pawl (15) and the longitudinal aperture in the head (11) and when the pawl is released the bottom edge (19) of this aperture will engage the ratcheted teeth (7) on the strap.

Two barbs (17) are formed out from the material of the pawl (8). They are bi-laterally symmetric and extrude out from the left and right exterior edge respectively of the pawl. The barb openings are oriented toward the top of the pawl and the bottoms of the barbs are fixed to the left and right exterior horizontal edges of the pawl. When the pawl is inserted (20) into the head (6), the barbs (17) engage the aforementioned steps (12) in the head aperture (13) and prevent extraction of the pawl (8).

Two springs (16) are formed out from the material of the pawl (8). They are bi-laterally symmetric and curvilinear in shape, are attached at the bottom left and right corners respectively of the pawl and open towards the lateral centerline of the pawl. When in contact with the bottom planar surface (18) of the aperture in the head (13) in which the pawl is placed, the springs impart sufficient upward force to the pawl (8) to abut the barbs (17) against the steps (12). When the pawl is pressed down, the springs are of sufficient flexibility to allow the pawl to move downward to release the ratcheted teeth (7).

A pawl release bar (14) is formed of the same material as the pawl of sufficient dimension to allow a human finger to comfortably press down the pawl and is located on the top edge of the pawl and centered on the lateral centerline of the pawl.

Observing Figures III and IV, a slide (9) is formed of injected or cut plastic, nylon or other suitable semi-rigid material. The slide is box shaped of sufficient height and depth to allow for a rectangular aperture (10) to be formed through the longitudinal centerline of the slide. The rectangular aperture shall be of sufficient dimension to allow the strap (2) and teeth (7) to pass through longitudinally. The slide shall be of sufficient length to provide enough friction between the interior planar surface of the aforementioned aperture and the exterior planar surface of the strap to fix the slide along the longitudinal centerline of the strap. The slide shall be located on the cord coupler between the two apertures (3 & 5) of the strap and having the strap (2) placed through the slide's aperture (10).

The releasable cord coupler, therefore, contains in a single embodiment, the strap with the tail, apertures, slot, and head. Within the head is the pawl and located circumferentially about the strap is the slide.

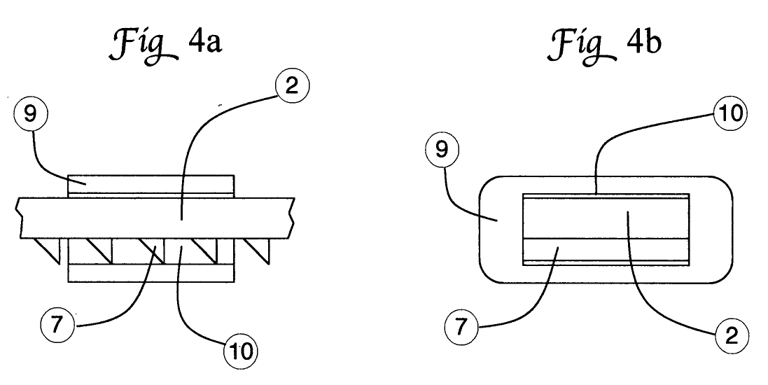

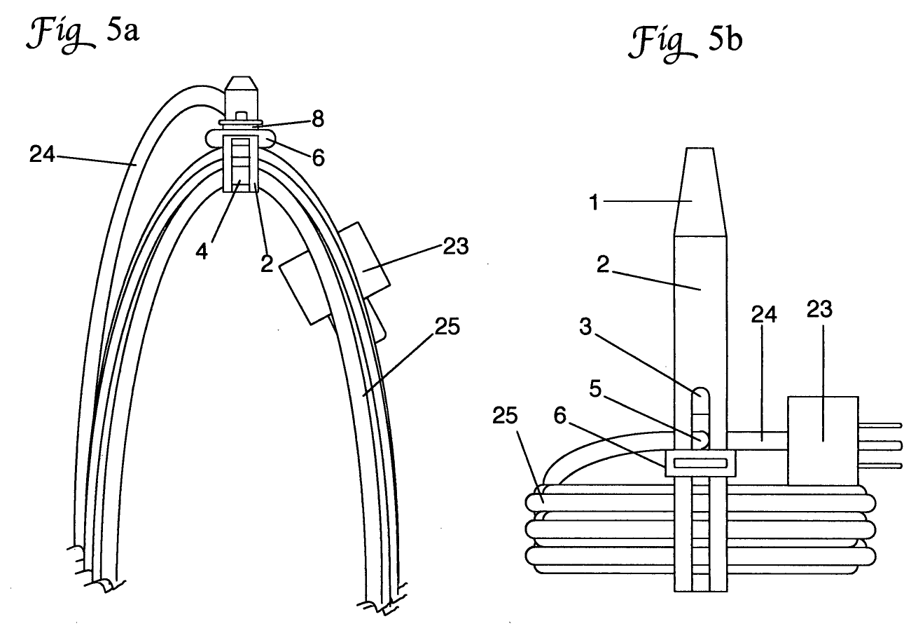

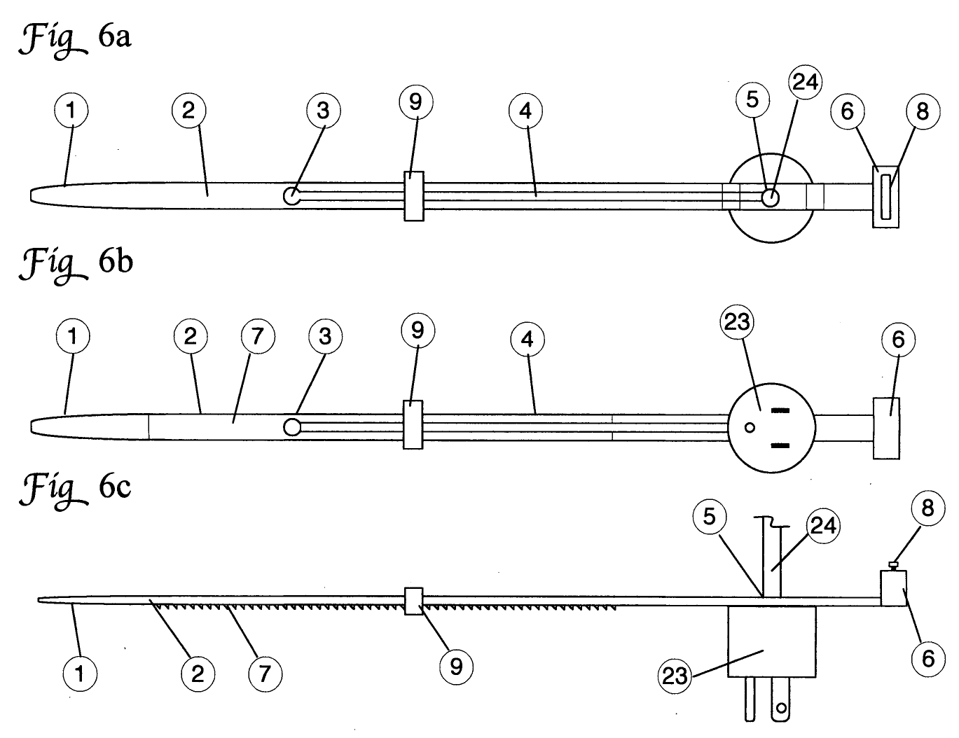

Observing FIG. 4: In operation, the slot (4) allows both the male (32) and female (30) plugs to pass through the center of the cord coupler to attach at the apertures. Next, the first aperture near the head (5) attaches the cord coupler to the male electrical plug electrical cord (33). Then, the second aperture near the tail (3) attaches the cord coupler to the female electrical plug electrical cord (31). The slide (9), positioned with the strap passing longitudinally through the center of the slide (10) and with the slide positioned between the two apertures on the strap, is then moved to secure the female electrical plug to the cord coupler. The male plug (32) is then inserted into the female plug (30). The tail end of the strap (1) is inserted into the head through the head aperture (11) forming a loop with the ratcheted teeth (7) oriented to engage the pawl (8). The pawl engages the ratcheted teeth on the strap preventing its removal until such time as the release bar on the pawl (14) is pressed and the lower edge of the pawl aperture aligns with the lower edge of the aperture in the head to allow the release of the strap. Thus, the cord coupler couples the male and female electrical plugs together to prevent accidental release.

Additionally, the cord coupler is used to secure an electrical cord to its electrical appliance. The male electrical plug of the electrical cord of an appliance remains inserted in the first aperture of the strap. The electrical cord of the appliance is then coiled around the handle or other portion of the appliance. The cord coupler is then looped around both the coiled electrical cord and the appliance handle. The tail is then inserted into the head. The cord coupler secures thusly the electrical cord to the appliance to prevent the cord unraveling during storage and transport.

The cord coupler may also be used to bind a coiled electrical extension cord. As above, the male electrical plug of an electrical extension cord remains inserted in the first aperture of the strap. The extension cord is then coiled into a loop. The tail of the cord coupler is then inserted through the center of the loop and then around the coiled cord to then be inserted into the head. The extension cord is bound into a coil by the cord coupler for storage or transport.

The cord coupler may also be manufactured as an integral part of an electrical cord or plug while retaining its function and basic form. The first aperture in the strap of the cord coupler is deleted and replaced with a permanent attachment to the electrical cord or plug through over-molding or injection molding. The slot in the strap of the cord coupler is reduced in length to allow only one electrical plug to pass through. In this embodiment, the cord coupler functions as claimed previously, but is permanently affixed to an electrical cord or plug.

What is claimed is:

1. A releasable cord coupler in a singular embodiment comprising:
a long flexible strap of injected or cut plastic, nylon or fiber reinforced rubber or other suitable flexible and tensionally strong material,
with a top planar surface enlongated in the longitudinal and narrow in the lateral dimensions through which is formed an aperture of sufficient diameter to accommodate circumferentially an electrical cord and located on the planar surface portion of the strap centered on the longitudinal axis near the head,
and a second aperture of sufficient diameter to accommodate circumferentially an electrical cord and located on the planar surface of the strap centered on the longitudinal axis a sufficient distance longitudinally from the first aperture to allow both male and female plugs to be uncoupled when the pawl is released,
and a substantially linear slot cut or molded between and bisecting the two apertures and centered on the longitudinal centerline that allows the male and female plugs to be inserted through the strap,
with a plurality of ratcheted teeth cut or molded into the bottom of the strap of sufficient depth to prevent uncoupling of the extension cord when tension is applied and shaped to allow insertion into the head without pressing the pawl and shaped to require pressing the pawl to release the strap from the receiver,
with a tail end that is tapered to reduce the width and height of the strap sufficiently to allow insertion into the head,
and with a head end located opposite the tail in the longitudinal direction and located on the top planar surface of the strap that has sufficient dimension to provide for a rectangular aperture transversing through the longitudinal direction that will allow the width and height of the strap to pass through the head, and a rectangular aperture passing down into the depth of the head, but not through, that allows the pawl to move up and down to engage and release the ratcheted teeth on the strap and with two steps located within this second aperture, one on each side in the lateral dimension, that provide an engagement planar surface for the two barbs of the pawl;
and a pawl of injected or cut plastic, nylon or other suitable semi-rigid material,
that is substantially planar in the lateral and depth dimensions,
of sufficient dimension in height and width to provide for a rectangular aperture of the same height and width as the strap to be cut or molded transversally through the longitudinal direction without material failure and to allow this same aperture to be moved up and down to engage and release the ratcheted teeth,
and of sufficient dimension in the longitudinal direction to engage the pawl in the space between any two ratcheted teeth without material failure,
with the exterior dimensions of the pawl not exceeding the dimensions of the head in which the pawl is contained,
with a rectangular aperture cut or molded through the planar surface centered on the lateral center line of the pawl of sufficient dimension to allow the strap to pass through longitudinally and positioned in height on the planar surface so that when the pawl is inserted in the head and pressed it will allow the strap to pass through both the aperture in the pawl and the longitudinal aperture in the head and when the pawl is released the bottom edge of this aperture will engage the ratcheted teeth,
with two barbs formed from the material of the pawl that are bi-laterally symmetric and are bent out from the left and right exterior edge respectively of the pawl with the opening toward the top of the barb and the bottom of the barb fixed to the left and right exterior edge so that when the pawl in inserted into the head, the barbs engage the aforementioned steps in the head aperture and prevent extraction of the pawl,
with two springs formed from the material of the pawl that are bi-laterally symmetric and curvilinear in shape and that are attached at the bottom left and right corners respectively of the pawl and open towards the lateral centerline of the pawl and that when in contact with the bottom planar surface of the aperture in the head in which the pawl is placed that sufficient upwards force is imparted to the pawl to abut the barbs against the steps and that when the pawl is pressed down that the springs are of sufficient flexibility to allow the pawl to release the strap,
with a release bar formed of the same material as the pawl of sufficient dimension to allow a human finger to comfortably press down the pawl and located on the top edge of the pawl and centered on the lateral centerline of the pawl and located within the aforementioned aperture in the head;
and a slide injected or cut plastic, nylon or other suitable semi-rigid material,
of sufficient height and depth to allow for an rectangular aperture to be formed through the longitudinal centerline of the slide without material failure,
with the rectangular aperture of sufficient dimension to allow the strap to pass through longitudinally,
of sufficient length to provide enough friction between the interior planar surface of the aforementioned aperture and the exterior planar surface of the strap to fix the slide along the longitudinal centerline of the strap,
and located on the apparatus between the two apertures within the strap and having the strap placed through the slide aperture;
and whereby the strap, in a single embodiment, contains the tail, apertures, slot, and head, serves as the mounting apparatus for the pawl and the slide, and provides the primary structural strength of the apparatus to prevent electrical cords from decoupling when placed under tension,
and whereby the slot allows both the male and female plugs to pass through the center of the cord coupler to attach at the apertures in the strap,
and whereby the first aperture near the head attaches the cord coupler to the male electrical plug electrical cord,
and whereby the second aperture near the tail attaches the cord coupler to the female electrical plug electrical cord,
and whereby the slide is positioned with the strap passing longitudinally through the center of the slide and the slide is positioned between the two apertures on the strap and is then moved to secure the female electrical plug to the cord coupler,
and whereby the male plug is then inserted into the female plug,
and whereby the tail end of the strap is inserted into the head forming a loop with the ratcheted teeth oriented to engage the pawl,
and whereby the pawl engages the ratcheted teeth on the strap preventing its removal until such time as the release bar on the pawl is pressed and the lower edge of the pawl aperture aligns with the lower edge of the aperture in the head to allow the release of the strap,
thereby coupling the male and female electrical plugs together to prevent accidental release.

2. A cord coupler of claim 1 wherein the cord coupler is used to secure an electrical cord to its electrical appliance
whereby the male electrical plug of the electrical cord of an appliance remains inserted in the first aperture of the strap,
and whereby the electrical cord of the appliance is then coiled around the handle or other portion of the appliance,
and whereby the cord coupler is then looped around both the coiled electrical cord and the appliance handle,
and whereby the tail is then inserted into the head as in claim 1,
thereby securing the electrical cord to the appliance to prevent the cord unraveling during storage and transport.

3. A cord coupler of claim 1 wherein the cord coupler is used to secure a coiled electrical extension cord
whereby the male electrical plug of an electrical extension cord remains inserted in the first aperture of the strap,
and whereby the extension cord is then coiled into a loop,
and whereby the tail of the cord coupler is then inserted through the center of the loop and then around the coiled cord to then be inserted into the head as in claim 1,
thereby securing the extension cord in a coil for storage or transport.

4. A cord coupler of claim 1 wherein the cord coupler is molded as an integral part of the electrical plug or cord
whereby the first aperture in the strap of the cord coupler of claim 1 is deleted and replaced with a permanent attachment to the electrical cord or plug,
and whereby the slot in the strap of the cord coupler in claim 1 is reduced in length to allow only one electrical plug to pass through,
thereby providing a cord coupler with the same functions as claims 1, 2 and 3, but permanently affixed to an electrical cord or plug.
